(19) United States
(12) Patent Application Publication
(10) Pub. No.: US 2009/0068375 A1
(43) Pub. Date: Mar. 12, 2009

(54) Atmospheric Pressure Plasma

(76) Inventors: Peter DOBBYN, Midleton (IE); Liam O'Neill, Midleton (IE)

Correspondence Address: HOWARD & HOWARD ATTORNEYS PLLC, 450 West Fourth Street, Royal Oak, MI, 48067, US

(21) Appl. No.: 12/206,005

(22) Filed: Sep. 8, 2008

(30) Foreign Application Priority Data
Sep. 10, 2007 (GB) GB 0717430.3

(51) Int. Cl. C08J 7/18; H05H 1/24

(52) U.S. Cl. 427/489; 427/569

(57) ABSTRACT

A process for plasma coating a surface in which an atomized surface treatment agent is incorporated in a non-equilibrium atmospheric pressure plasma generated in a noble process gas and the surface to be treated is placed in contact with the atmospheric pressure plasma containing the atomized surface treatment agent, characterized in that particle content of the coating formed on the surface is reduced by incorporating a minor proportion of nitrogen in the process gas.

This invention relates to a process for generating a non-equilibrium atmospheric pressure plasma in a process gas and to a process for plasma treating a surface with a non-equilibrium atmospheric pressure plasma thus generated.

When matter is continually supplied with energy, its temperature increases and it typically transforms from a solid to a liquid and, then, to a gaseous state. Continuing to supply energy causes the system to undergo a further change of state in which neutral atoms or molecules of the gas are broken up by energetic collisions to produce negatively charged electrons, positive or negatively charged ions and other species. This mix of charged particles exhibiting collective behaviour is called “plasma”. Due to their electrical charge, plasmas are highly influenced by external electromagnetic fields which make them readily controllable. Furthermore, their high energy content allows them to achieve processes which are impossible or difficult through the other states of matter, such as by liquid or gas processing.

The term “plasma” covers a huge range of systems whose density and temperature vary by many orders of magnitude. Some plasmas are very hot and all their microscopic species (ions, electrons, etc.) are in approximate thermal equilibrium, the energy input into the system being widely distributed through atomic/molecular level collisions. Other plasmas, however, particular those at low pressure (e.g. 100 Pa) where collisions are relatively infrequent, have their constituent species at widely different temperatures and are called “non-thermal equilibrium” plasmas. In these non-thermal plasmas, the free electrons are very hot with temperatures of many thousands of degrees Kelvin whilst the neutral and ionic species remain cool. Because the free electrons have almost negligible mass, the total system heat content is low and the plasma operates close to room temperature thus allowing the processing of temperature sensitive materials, such as plastics or polymers, without imposing a damaging thermal burden onto the sample. However, the hot electrons create, through high energy collisions, a rich source of radicals and excited species with a high chemical potential energy capable of profound chemical and physical reactivity. It is this combination of low temperature operation plus high reactivity which makes non-thermal plasmas technologically important and a very powerful tool for manufacturing and material processing, capable of achieving processes which, if achievable at all without plasma, would require very high temperatures or noxious and aggressive chemicals.

Non-thermal equilibrium plasmas are effective for many technological applications, for example surface activation, surface cleaning, material etching and coating of surfaces. The microelectronics industry has developed low pressure glow discharge plasma into a high technology and high capital cost engineering tool for semiconductor, metal and dielectric processing. The same low pressure glow discharge type plasma has increasingly penetrated other industrial sectors, offering polymer surface activation for increased adhesion/bond strength, high quality degreasing/cleaning and the deposition of high performance coatings.

Atmospheric pressure plasma discharges such as atmospheric pressure dielectric barrier discharge and atmospheric pressure glow discharge offer alternative homogeneous plasma sources, which have many of the benefits of vacuum plasma methods, while operating at atmospheric pressure. In particular they can provide homogeneous (uniform), substantially non-filamentary diffuse plasma discharges at or around atmospheric pressure. EP0790525 describes an atmospheric pressure glow discharge system for the promotion of adhesion in photographic applications, in which a helium process gas is used either alone or in combination with 0.1 to 8% of nitrogen and/or 0.1 to 8% oxygen. EP0790525 utilises this system as a means of surface activation and does not discuss the application of coatings.

The use of such atmospheric pressure plasma discharge systems was significantly developed in the 1980's, for example as described in Kanazawa S., Kogoma M., Moriwaki T., Okazaki S., J. Phys. D: Appl. Phys., 21, 838-840 (1988) and Roth J. R., Industrial Plasma Engineering, Volume 2 Applications to Nonthermal Plasma Processing, Institute of Physics Publishing, 2001, pages 37-73. WO 01/59809 and WO 02/35576 describe a series of plasma producing systems which provide a uniform, homogeneous plasma at ambient pressure by application of a 50 to 80 kHz RF voltage across opposing parallel plate electrodes separated by about 10 mm. The ambient pressure and temperature ensures compatibility with open perimeter, continuous, on-line processing.

Corona and flame are other plasma treatment systems, but have significant limitations. Flame systems are typically at thermal equilibrium. Flame systems can be extremely effective at depositing coatings, but operate at high temperatures and are only suitable for substrates such as metals and ceramics. Corona systems often give non-uniform treatment of surfaces, as the corona discharge is a non-homogeneous discharge of a filamentary nature generated between a point and plane electrode, with typically the substrate being supported by the planar electrode.

U.S. Pat. Nos. 5,198,724 and 5,369,336 describe a “cold” or non-thermal equilibrium atmospheric pressure plasma jet. The system used to produce the atmospheric pressure plasma jet consisted of an RF powered metal needle acting as a cathode, surrounded by an outer cylindrical anode. U.S. Pat. No. 6,429,400 describes a system for generating a blown atmospheric pressure glow discharge. This comprises a central electrode separated from an outer electrode by an electrical insulator tube.

U.S. Pat. No. 5,837,958 describes an atmospheric pressure plasma jet based on coaxial metal electrodes where a powered central electrode and a dielectric coated ground electrode are utilized. A portion of the ground electrode is left exposed to form a bare ring electrode near the gas exit. The gas flow (air or argon) enters through the top and is directed to form a vortex, which keeps the arc confined and focused to form a plasma jet. To cover a wide area, a number of jets can be combined to increase the coverage.

U.S. Pat. No. 6,465,964 describes an alternative system for generating an atmospheric pressure plasma jet, in which a pair of electrodes are placed around a cylindrical tube. Process gas enters through the top of the tube and exits through the bottom. When an AC electric field is supplied between the two electrodes, a plasma is generated by passing a process gas there between within the tube and this gives rise to an atmospheric pressure plasma jet at the exit. The position of the electrodes ensures that the electric field forms in the axial direction.

WO 02/28548 describes a method for forming a coating on a substrate by introducing an atomized liquid and/or solid coating material into an atmospheric pressure plasma discharge or an ionized gas stream resulting therefrom. WO 02/098962 describes coating a low surface energy substrate by exposing the substrate to a silicon compound in liquid or gaseous form and subsequently post-treating by oxidation or reduction using a plasma or corona treatment, in particular a pulsed atmospheric pressure glow discharge or dielectric barrier discharge. WO 03/085693 describes an atmospheric plasma generation assembly having one or more parallel electrode arrangements adapted for generating a plasma, means for introducing a process gas and an atomizer for atomizing and introducing a reactive agent. The assembly is such that the only exit for the process gas and the reactive agent is through the plasma region between the electrodes.

WO 03/097245 and WO 03/101621 describe applying an atomized coating material onto a substrate to form a coating. The atomized coating material, upon leaving an atomizer such as an ultrasonic nozzle or a nebulizer, passes through an excited medium (plasma) to the substrate. The substrate is positioned remotely from the excited medium. The plasma is generated in a pulsed manner.

WO 2006/048649 describes a process for generating a non-equilibrium atmospheric pressure plasma incorporating an atomized surface treatment agent in which a radio frequency high voltage is applied to one or more electrodes positioned within a dielectric housing having an inlet and an outlet while causing a process gas to flow from the inlet past the electrode to the outlet, the voltage being sufficiently high to generate a non-equilibrium atmospheric pressure plasma at the electrode(s). The atomized surface treatment agent is incorporated in the plasma within the dielectric housing. The plasma extends at least to the outlet of the housing, and a surface to be treated can be positioned adjacent to the plasma outlet and moved relative to the plasma outlet. WO 2006/048650 describes a similar process in which a tube formed at least partly of dielectric material extends outwardly from the outlet of the housing and the end of the tube forms the plasma outlet.

In surface treatments using non-equilibrium atmospheric pressure plasma, it is usually desirable to have a plasma which is as uniform as possible to achieve a surface treatment which is as uniform as possible. We have found according to the present invention that addition of nitrogen to a helium or argon plasma can substantially reduce the tendency of the system to form a filamentary plasma. Although some of the published patent documents listed above mention the possibility of forming a non-equilibrium atmospheric pressure plasma in a mixed process gas, it is standard practice to use a pure gas as the process gas.

When a plasma is operated in a filamentary mode, then any surface treatment carried out is likely to produce localized regions of high energy treatment and consequent surface damage and uneven surface treatment. Adding some nitrogen to an atmospheric pressure plasma formed using helium or argon as process gas can stabilize the plasma in a more diffuse, non-filamentary mode. As there are no filaments, this prevents the plasma from damaging the substrate and producing uneven surface treatment.

The improved uniformity of the plasma can be seen with the naked eye by observing a decrease in filaments or striations in the plasma discharge from the process gas containing a small proportion of nitrogen compared to the discharge from the pure noble process gas. If a conductive or semi-conductive substrate is placed in contact with the plasma, the improved uniformity can be seen by reduced sparking at the substrate surface.

We have found surprisingly that adding some nitrogen also has a significant effect upon coatings deposited via non-equilibrium atmospheric pressure plasma, for example by incorporation of an atomized surface treatment agent in a plasma jet as described in WO 2006/048649 or WO 2006/048650.

Thus according to one aspect of the invention a process for coating a surface, in which an atomized surface treatment agent is incorporated in a non-equilibrium atmospheric pressure plasma generated in a noble process gas or an excited and/or ionized gas stream resulting therefrom, and the surface to be treated is positioned to receive atomized surface treatment agent which has been incorporated therein (i.e. in the non-equilibrium atmospheric pressure plasma generated in a noble process gas or an excited and/or ionized gas stream resulting therefrom), is characterized in that the particle content of the coating formed on the surface is reduced by incorporating a minor proportion of nitrogen in the process gas.

Preferably the non-equilibrium atmospheric pressure plasma can be generated in a process gas comprising the noble gas and the atomized surface treatment agent, or the atomized surface treatment agent can be introduced into a non-equilibrium atmospheric pressure plasma generated in the noble process gas. Preferably the surface to be treated is additionally activated by being placed in contact with the atmospheric pressure plasma or the excited and/or ionized gas stream resulting therefrom.

In one preferred embodiment there is provided a process for plasma coating a surface, in which an atomized surface treatment agent is incorporated in a non-equilibrium atmospheric pressure plasma generated in a noble process gas and the surface to be treated is placed in contact with the atmospheric pressure plasma containing the atomized surface treatment agent, is characterized in that the particle content of the coating formed on the surface is reduced by incorporating a minor proportion of nitrogen in the process gas.

The atomized surface treatment agent, typically in a liquid form, can for example be a polymerizable precursor. When a polymerizable precursor is introduced into the plasma jet, preferably as an aerosol, a controlled plasma polymerization reaction occurs which results in the deposition of a polymer on any substrate which is placed adjacent to the plasma outlet. A range of functional coatings can be deposited onto various substrates. These coatings are grafted to the substrate and retain the functional chemistry of the precursor molecule. We have found that when a filamentary plasma is used, the deposited coatings contain significant amounts of particles and the coatings are not clear and smooth. Whilst not being tied to current theories it is believed that this particle formation may be due to the high energy filaments producing accelerated polymerization to form polymer particles within the plasma and that the resultant particles are incorporated in to the deposited coating. Adding some nitrogen to the plasma facilitates the deposition of coatings with significantly less particle inclusions.

The reduced particle content of the coating can be measured by increased clarity of the coating and/or by reduced surface roughness of the coating. A coating containing no particles should generally be clear and transparent, while a coating containing particles has a whitish and more opaque appearance. The light transmittance of the coating can be measured. The lower surface roughness of a coating containing less particles may be sensed by touch, or can be measured by instrument.

The non-equilibrium atmospheric pressure plasma can be a plasma jet or other diffuse plasma discharge or a glow discharge plasma and is generally a “low temperature” plasma wherein the term “low temperature” is intended to mean below 200° C., and preferably below 100° C. Low temperature plasmas are plasmas where collisions are relatively infrequent (when compared to thermal equilibrium plasmas such as flame based systems) and which have their constituent species at widely different temperatures (hence the general name “non-thermal equilibrium” plasmas). In the case of plasma jet type discharges having pin or point type electrodes the discharge may be in the form of a corona glow which is the glow around the electrode caused by electrons during gas ionization and ion cascade. In true corona systems filaments produced will extend from the point electrode to the substrate surface but in corona glow type systems seen with plasma jet equipment having pin or point type electrodes only micro-filaments can be observed in the proximity of the point electrode. Such micro-filaments do not extend to the substrate and therefore such plasma jet equipment is not a true corona type discharge system.

In one preferred device according to the invention for generating a non-equilibrium atmospheric pressure plasma, the radio frequency high voltage is applied to at least one electrode positioned within a dielectric housing having an inlet and an outlet while causing the said process gas to flow from the inlet past the electrode to the outlet, as described for example in WO 2006/048649. The plasma preferably extends as a flame-like jet from the electrode to the outlet of the housing. The surface to be treated is positioned adjacent to the outlet so that the surface is in contact with the plasma and is moved relative to the plasma outlet. The process of the invention is particularly applicable to this type of device, where it is more difficult to achieve a uniform non-filamentary plasma diffuse discharge than in a device generating the atmospheric pressure plasma between two substantially parallel electrodes.

Such a device may have only a single electrode. Despite the lack of a counter electrode, the device still gives rise to a plasma jet. The presence of a powered electrode in the vicinity of a working gas such as helium is sufficient to generate a strong RF field. A plasma is formed by the excitement of the gaseous atoms and molecules caused by the effects of this RF field. The gas becomes ionized generating chemical radicals, UV-radiation, excited neutrals and ions which can give rise to a plasma ionization process and form an external plasma jet. A bare metal electrode can be used. For example a single electrode may be housed within a dielectric housing such as a plastic tube through which the process gas, and optionally the atomized surface treatment agent flow. As power is applied to the electrode, an electric field forms and the process gas is ionized. The use of a metal electrode facilitates plasma formation. Electrodes can be coated or incorporate a radioactive element to enhance ionization of the plasma.

The plasma jet device can alternatively consist of a single hollow electrode, without any counter electrode. Process gas is blown through the centre of the electrode. RF power is applied and this leads to the formation of strong electro-magnetic fields in the vicinity of the electrode. This causes the gas to ionize and a plasma forms which is carried through the electrode and exits as a plasma jet. The narrow nature of this design allows for focused, narrow plasmas to be generated under ambient conditions for depositing functional coatings on a three-dimensionally shaped substrate.

More generally, the electrode or electrodes can take the form of pins, plates, concentric tubes or rings, or needles via which gas can be introduced into the apparatus. A single electrode can be used, or a plurality of electrodes can be used. The electrodes can be covered by a dielectric, or not covered by a dielectric. If multiple electrodes are used, they can be a combination of dielectric covered and non-covered electrodes. One electrode can be grounded or alternatively no electrodes are grounded (floating potential). If no electrodes are grounded, the electrodes can have the same polarity or can have opposing polarity. A co-axial electrode configuration can be used in which a first electrode is placed co-axially inside a second electrode. One electrode is powered and the other may be grounded, and dielectric layers can be included to prevent arcing.

The non-equilibrium atmospheric pressure plasma may be generated between two electrodes having an atmosphere of the said process gas between them. For example, the plasma can be generated in a gap between two electrodes with the process gas flowing through the gap in the direction perpendicular to the length of the electrodes, forming a plasma knife extending outwards from the gap between the electrodes.

The power supply to the electrode or electrodes is a high or radio frequency power supply as known for plasma generation, that is in the range 1 kHz to 300 kHz. Our most preferred range is the very low frequency (VLF) 3 kHz-30 kHz band, although the low frequency (LF) 30 kHz-300 kHz range can also be used successfully. Frequencies within the range 10 kHz to 40 kHz, and particularly within the range 18 kHz-28 kHz, are most preferred. The high or radio frequency power supply used in the non-thermal equilibrium plasma equipment may be operated in either continuous mode or pulse mode, for example by using a pulsed signal generator 126 to trigger the output from the RF generator. One suitable power supply is the Haiden Laboratories Inc. PHF-2K unit which is a bipolar pulse wave, high frequency and high voltage generator. It has a faster rise and fall time (<3 μs) than conventional sine wave high frequency power supplies. The frequency of the unit is variable between 1-100 kHz.

The noble gas which forms the major proportion of the process gas can for example be helium or argon. Helium may be preferred as plasmas can generally be fired at lower voltages using helium as process gas than with argon. In a process comprising applying a radio frequency high voltage to at least one electrode positioned within a dielectric housing while causing a noble process gas to flow from the inlet of the housing past the electrode to the outlet, the flow rate of the helium or other noble gas is preferably in the range 0.5 to 10 or 25 standard litres/minute.

The amount of nitrogen incorporated in the process gas is generally at least 0.2% by volume and preferably at least 0.5% by volume. The amount of nitrogen can be up to 10% by volume or even more. The optimum amount of nitrogen may vary according to the noble gas used and its flow rate, the power applied by the RF generator, and the chemical nature of the surface treatment agent used and of the surface to be treated. In general a higher level of nitrogen is required at higher power. Below 25 kV, for example at 10-25 kV, the preferred level of nitrogen is 0.2 to 5% by volume. Above 25 kV, the preferred level of nitrogen is 0.5 to 10% by volume. Under most conditions the optimum level of nitrogen is in the range 1 to 5% by volume of a helium process gas. The process gas can contain a further gas such as carbon dioxide if desired, although any such further gas is preferably used at less than 5% by volume of the process gas.

Examples of surface treatment agents which can be incorporated in the atmospheric pressure plasma include polymerizable organic coating-forming materials, particularly olefinically unsaturated materials including methacrylates, acrylates, styrenes, nitriles, alkenes and dienes, for example methyl methacrylate, ethyl methacrylate, propyl methacrylate, butyl methacrylate, and other alkyl methacrylates, and the corresponding acrylates, including organofunctional methacrylates and acrylates such as poly(ethyleneglycol)acrylates and methacrylates, glycidyl methacrylate, allyl methacrylate, hydroxyethyl methacrylate, hydroxypropyl methacrylate, dialkylaminoalkyl methacrylates, and fluoroalkyl(meth)acrylates, for example heptadecylfluorodecyl acrylate (HDFDA) of the formula

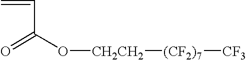

methacrylic acid, acrylic acid, fumaric acid and esters, itaconic acid (and esters), maleic anhydride, styrene, α-methylstyrene, halogenated alkenes, for example, vinyl halides, such as vinyl chlorides and vinyl fluorides, and fluorinated alkenes, for example perfluoroalkenes, acrylonitrile, methacrylonitrile, ethylene, propylene, allyl amine, vinylidene halides, butadienes, acrylamide, such as N-isopropylacrylamide, methacrylamide, phosphorus-containing compounds, for example dimethylallylphosphonate, and acrylic-functional organosiloxanes and/or silanes such as trimethoxysilyl propyl methacrylate.

The surface treatment agent can alternatively be an organosilicon compound. Suitable organosilicon compounds silanes (for example, silane, alkylsilanes, alkylhalosilanes, alkoxysilanes such as tetraethoxysilane or epoxyalkylsilanes such as glycidoxypropyltrimethoxysilane,) and linear (for example, polydimethylsiloxane or polyhydrogenmethylsiloxane) and cyclic siloxanes (for example, octamethylcyclotetrasiloxane or tetramethylcyclotetrasiloxane), including organo-functional linear and cyclic siloxanes (for example halo-functional, and haloalkyl-functional linear and cyclic siloxanes such as tri(nonofluorobutyl)trimethylcyclotrisiloxane). The coating formed on a surface with an atmospheric pressure plasma containing such an organosilicon compound generally comprises a polyorganosiloxane. A mixture of different silicon-containing materials may be used, for example to tailor the physical properties of the substrate coating for a specified need (e.g. thermal properties, optical properties, such as refractive index, and viscoelastic properties).

The surface treatment agent can alternatively be an organic coating-forming material polymerizing by condensation and/or ring-opening polymerization, such as an epoxy compound, for example glycidol, styrene oxide, butadiene monoxide, ethyleneglycol diglycidylether, glycidyl methacrylate, bisphenol A diglycidylether (and its oligomers) or vinylcyclohexene oxide, or a heterocyclic compound polymerizing to a conducting polymer such as pyrrole and thiophene and their derivatives.

In general, a higher level of nitrogen based on noble process gas is required to reduce filament formation in an atmospheric pressure plasma containing an organosilicon compound for forming a polysiloxane coating than for a plasma containing a monomer for forming a polyacrylate coating. For example, when the surface treatment agent is a siloxane, a helium atmospheric pressure plasma can be stabilized at low applied voltage (up to 25 kV, for example 20-25 kV), with 1% by volume nitrogen. If the applied voltage is raised, for example to 30 kV, 3-5% by volume nitrogen may be required to give optimum reduction of filament formation in the plasma and clarity and smoothness of the polysiloxane coating formed on a substrate. However, when the surface treatment agent is a polymerizable fluoromonomer such as a fluoroacrylate, addition of 0.5 to 1% by volume nitrogen to helium process gas substantially reduces filament formation in the atmospheric pressure plasma.

Typically the surface treatment agent is a liquid which is introduced in an atomized form. The concentration of surface treatment agent, for example coating precursor, is preferably in the range 0.1 to 30 μl liquid surface treatment agent per standard litre of process gas.

The atomizer for the surface treatment agent can be positioned within the housing through which the process gas flows. For example, an atomizing device such as a pneumatic nebulizer or an ultrasonic atomizer can be positioned with its exit between two electrodes within a dielectric housing having an inlet for process gas so that the gas flows between the electrodes approximately parallel to the atomized liquid from the atomizer. The atomizer preferably uses a gas to atomize the surface treatment agent. The process gas used for generating the plasma can be used as the atomizing gas to atomize the surface treatment agent. The atomizer can alternatively be positioned to deliver the atomized surface treatment agent into the plasma downstream of the electrode(s) and process gas inlet. A plurality of atomizers can be used, for example to form a copolymer coating on a substrate from two different coating-forming materials which are immiscible.

The atomizer can for example be a pneumatic nebulizer, particularly a parallel path nebulizer such as that sold by Burgener Research Inc. of Mississauga, Ontario, Canada, or that described in U.S. Pat. No. 6,634,572. The atomizer can alternatively be an ultrasonic atomizer in which a pump is used to transport the liquid surface treatment agent into an ultrasonic nozzle and subsequently it forms a liquid film onto an atomizing surface. Ultrasonic sound waves cause standing waves to be formed in the liquid film, which result in droplets being formed. The atomizer preferably produces drop sizes of from 10 to 100 μm, more preferably from 10 to 50 μm. Suitable atomizers for use in the present invention are ultrasonic nozzles from Sono-Tek Corporation, Milton, N.Y., USA. Alternative atomizers may include for example electrospray techniques, methods of generating a very fine liquid aerosol through electrostatic charging. The most common electrospray apparatus employs a sharply pointed hollow metal tube, with liquid pumped through the tube. A high-voltage power supply is connected to the outlet of the tube. When the power supply is turned on and adjusted for the proper voltage, the liquid being pumped through the tube transforms into a fine continuous mist of droplets. Inkjet technology can also be used to generate liquid droplets without the need of a carrier gas, using thermal, piezoelectric, electrostatic and acoustic methods.

When the non-equilibrium atmospheric pressure plasma is generated by applying a radio frequency high voltage to at least one electrode positioned within a dielectric housing while causing the said process gas to flow from the inlet of the housing past the electrode to the outlet, a tube formed at least partly of dielectric material may extend outwardly from the outlet of the housing, whereby the end of the tube forms the plasma outlet and the plasma extends from the electrode to said plasma outlet. The use of a length of tubing in this way allows a non-equilibrium atmospheric pressure plasma discharge jet to be stabilized over considerable distances, for example at least 150 mm or even over 300 mm. This is of advantage when treating conductive or semiconductive substrates, as if the distance between the electrode and the substrate is too small there is a tendency for the plasma to break down and form a high temperature arc between the powered electrode(s) and the substrate. Whilst the inclusion of a minor proportion of nitrogen in the noble process gas helps reduce arcing, it may still be of advantage to extend the plasma jet in a tube.

The tube extending the non-equilibrium plasma jet is formed at least partly of dielectric material such as plastics, for example polyamide, polypropylene or PTFE. The tube is preferably flexible so that the plasma outlet can be moved relative to the substrate. In order to stabilize the plasma jet over lengths greater than 300 mm., it is beneficial to use conductive cylinders, preferably with sharp edges, to connect adjacent pieces of pipe. These cylinders are preferably not grounded. Preferably, these rings have a round sharp edge on both sides. As it passes inside these metal cylinders, the process gas is in contact with metal. The free electrons created inside the plasma region induce a strong electric field near sharp conductive edges that ionize further the process gas inside the pipe. The sharp edge on the other side of the cylinder creates a strong electric field that initiates the ionization of the gas in the following pipe section. In this way the plasma inside the pipe is extended. Use of multiple metal connectors enables the plasma to be extended over several metres, if required, as described in WO 2006/048650.

The process of the invention can also be applied to plasma generation in an assembly having one or more parallel electrode arrangements, as described for example in WO 02/028548 or WO03/085693. The electrodes may comprise a housing having an inner and outer wall, wherein the inner wall is formed from a non-porous dielectric material, and which housing retains a non-metallic electrically conductive material, as described in WO 2004/068916. The assembly may comprise first and second pairs of vertically arrayed, parallel spaced-apart planar electrodes with a dielectric plate between each pair adjacent one electrode, with an atomizer (74) adapted to introduce an atomized coating material into the first or second plasma region between the electrodes. The assembly comprises means of transporting a substrate through the or both plasma regions between the electrodes. The use of nitrogen may give less added benefit in such parallel electrode assemblies, since uniformity of the atmospheric pressure plasma discharge is rarely a problem in these assemblies.

The process of the invention is of particular benefit in plasma coating conductive and semiconductive substrates, particularly substrates used in the electronics industry such as silicon and gallium nitride semiconductor wafers, printed circuit boards, displays including flexible displays, and electronic components such as resistors, diodes, capacitors, transistors, light emitting diodes, laser diodes, integrated circuits (ic), ic die, ic chips, memory devices, logic devices, connectors, keyboards, solar cells and fuel cells. For example a polyorganosiloxane dielectric coating can be formed on silicon wafers or an oleophobic and hydrophobic fluoropolymer coating can be formed on circuit boards. A dielectric coating layer can be deposited on the rear surface of the semiconductor substrate of a photovoltaic device used in a solar cell.

Other materials which can be coated according to the invention include optical components such as lenses including contact lenses, military, aerospace and transport equipment and parts thereof such as gaskets, seals, profiles, hoses and electronic and diagnostic components, household articles including kitchen, bathroom and cookware, office equipment and laboratory ware. Any suitable coatings may be applied, for example coatings for surface activation, anti-microbial, friction reduction (lubricant), bio-compatible, corrosion resistant, oleophobic, hydrophilic, hydrophobic, barrier, self cleaning, or print adhesion, or coatings containing active materials as described in WO2005/110626.

In a further embodiment of the invention there is provided the use of nitrogen at a minor proportion in the process gas to improve the uniformity of a non-equilibrium atmospheric pressure plasma generated in a noble process gas by applying a radio frequency high voltage to at least one electrode in contact with an atmosphere of the noble process gas. Use of nitrogen at a minor proportion in the process gas to improve the uniformity of a non-equilibrium atmospheric pressure plasma generated in a noble process gas by applying a radio frequency high voltage to at least one electrode in contact with an atmosphere of the noble process gas. Preferably the noble gas is helium or argon.

A process according to the invention for generating a non-equilibrium atmospheric pressure plasma in a process gas by applying a radio frequency high voltage to at least one electrode in contact with the process gas is characterized in that the process gas comprises a noble gas and nitrogen in a proportion of from 90 parts by volume noble gas to 10 parts nitrogen up to 99.8 parts by volume noble gas to 0.2 parts nitrogen.

The invention will now be described with reference to the accompanying drawings, in which

FIG. 1 is a perspective view of an apparatus for generating a non-equilibrium atmospheric pressure plasma suitable for use according to the invention:

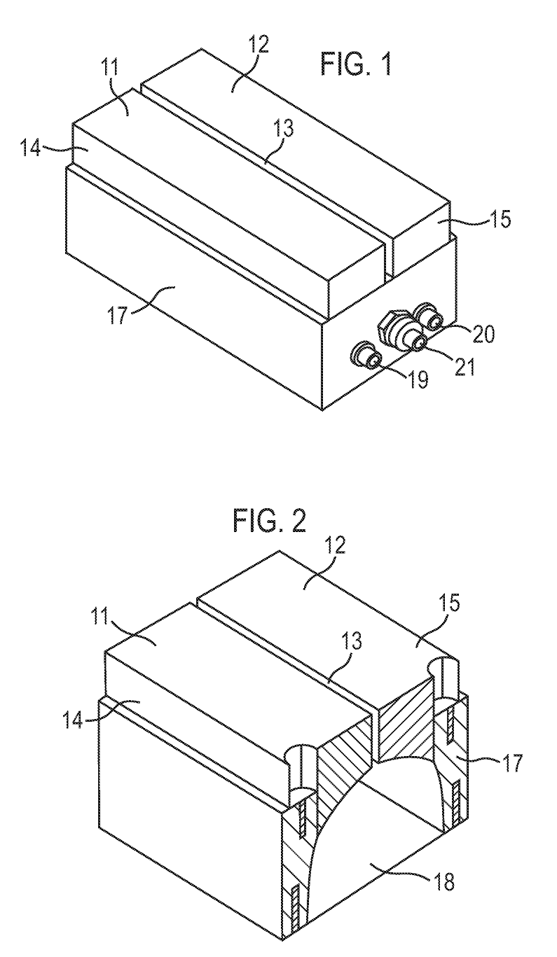

FIG. 2 is a view partly in cross-section of the apparatus of FIG. 1;

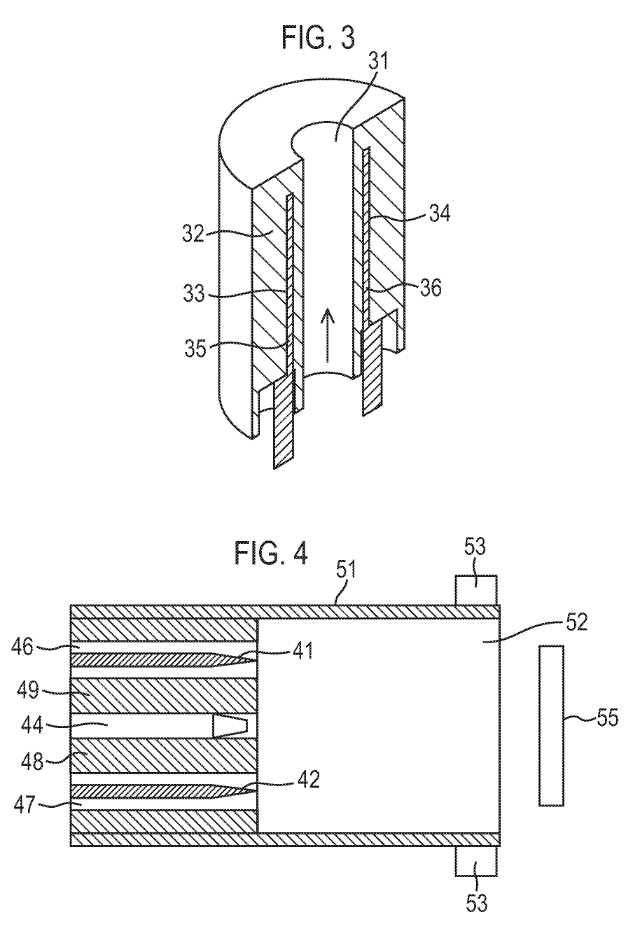

FIG. 3 is a diagrammatic cross-sectional view of an alternative apparatus for generating a non-equilibrium atmospheric pressure plasma suitable for use according to the invention; and

FIG. 4 is a diagrammatic cross-section of a further alternative apparatus for generating a non-equilibrium atmospheric pressure plasma suitable for use according to the invention.

The apparatus of FIGS. 1 and 2 comprises two opposed electrodes 11, 12 having a gap 13 between them of about 4 mm. The electrodes 11, 12 are connected to a high voltage RF frequency supply (not shown). One electrode 11 was covered with a dielectric material and the other electrode 12 had a roughened surface to facilitate plasma formation. These electrodes were mounted inside polytetrafluoroethylene (PTFE) housings 14, 15, which were attached to a housing 17 which surrounds a process gas chamber 18. The housing 17 has inlet ports 19, 20 for process gas and an inlet port 21 for an atomized surface treatment agent. The chamber 18 can act as a mixing chamber for different process gases and/or for process gas and atomized surface treatment agent. The only exit from process gas chamber 18 is through the gap 13. When a RF high voltage is applied to the electrodes 11, 12 and process gas is fed to the chamber 18 a non-equilibrium atmospheric pressure plasma is formed in gap 13 and extends outwards beyond the electrodes as a plasma knife, which can be used to treat substrates.

When pure helium was used as the process gas, a plasma flame was produced extending about 30 mm. from the electrodes 11, 12. Close observation of the flame revealed that it consisted of multiple micro-discharges, which were blown out from the plasma gap 13 by the gas as it leaves the chamber 18.

When a small amount of nitrogen, for example 4% by volume, was added to the helium it had a significant effect on the plasma. The micro-discharges disappeared and were replaced by what appeared to be a uniform diffuse discharge in the plasma gap 13 between the electrodes 11, 12. This plasma extended out beyond the electrodes as a plasma knife, although the plasma knife was not as long as that generated by a pure helium discharge; it was about 15 mm. The plasma knife could be used to activate substrates. If an atomized surface treatment agent was fed to the chamber 18 with the process gas, the plasma knife could be used to deposit coatings on a substrate. Coatings deposited on a metal substrate using nitrogen in the process gas were smoother than coatings deposited using helium without nitrogen as the process gas.

In the apparatus of FIG. 3, a shaft 31 was bored through the middle of a PTFE cylinder 32 to carry a flow of helium process gas, and optionally atomized surface treatment agent, in the direction indicated. Two smaller holes 33, 34 were bored at either side of the main shaft 31. Metal wires were inserted into each of these side shafts 33, 34 to form electrodes 35, 36. When a RF high voltage was applied between these electrodes, a plasma formed in the shaft 31 which could be blown by the gas flow to form a jet.

When pure helium was passed through the shaft 31 and RF power was applied to the electrodes 35, 36 at a frequency of 18 kHz and at 50% power requested from a 100 W RF generator, a homogeneous plasma was produced which formed a long stable jet. As the applied power increased, the plasma became filamentary. Adding nitrogen at 5% by volume to the helium gas flow was found to stabilize the uniform diffuse mode of operation at voltages up to 80% power requested from the 100 W RF generator and to prevent filamentary plasma modes from forming.

The plasma jet of FIG. 4 consisted of an electrode assembly of metal electrodes 41, 42 surrounding a nebulizer 44 through which a coating precursor could be introduced as a fine aerosol mist. The plasma process gas is passed through apertures 46, 47 surrounding the electrodes 41, 42. The electrodes are separated from each other and from the nebulizer by dielectric screens 48, 49 and the apparatus is contained within a tubular dielectric housing 51. A dielectrically covered and grounded counter electrode 53 is placed surrounding the exit 52 of the housing 51.

Applying RF power to the electrodes 41, 42 produces a plasma downstream of the nebulizer 44. If a polymerizable coating precursor is passed through the nebulizer 44, a polymerization reaction takes place as the aerosol from the nebulizer passes through the plasma. A polymer coating can be deposited on any substrate such as 55 placed adjacent to the exit 52 of the housing 51.

If the apparatus of FIG. 4 is operated without a substrate 55 adjacent to the exit 52 of the housing 51, or with a dielectric substrate 55, the plasma is non-filamentary whether or not the counter electrode 53 is present and whether or not the noble process gas fed through apertures 46, 47 contains nitrogen. When the substrate 55 is conductive or semiconductive, the plasma formed with a pure helium or pure argon process gas feed has a tendency to form a filamentary discharge between the electrodes 41, 42 and the substrate 55. This results in uneven surface treatment. The system does not deposit a smooth, clear and adherent coating. Instead the localized regions of high power give rise to the formation of particles. When the grounded counter electrode 53 was present, it provided an alternate ground path and removed many of the filaments. However, when treating a conductive or semiconductive substrate 55 with sharp points or when operating at high power with a pure helium or pure argon process gas feed, the system was still prone to occasional arcing.

When nitrogen was added to the process gas flow through apertures 46, 47, it was found to reduce filament formation whether or not counter electrode 53 was in operation. The plasma was stabilized as a non-filamentary discharge when the noble gas forming the major component of the process gas was helium, and when the noble process gas was argon. Combining the addition of nitrogen to the process gas flow with the use of grounded counter electrode 53 produced a plasma that was filament free even with a conductive substrate 55, allowing the plasma jet to coat a range of conductive and semiconductive substrates.

The invention is illustrated by the following Examples.

### EXAMPLE 1

A plasma was formed using the apparatus of FIG. 4, with a dielectrically covered and grounded counter electrode 53 placed around the exit of the housing 51. Helium was introduced at 7 standard litres/minute (slm) and nitrogen was supplied at 50 standard cubic centimetres per minute (sccm) through process gas feed apertures 46, 47. RF power was applied at a frequency of 18 kHz and at 80% power requested from a 100 W RF generator. This produced a uniform and filament free plasma. A fluorocarbon precursor, heptadecafluorodecyl acrylate, was nebulized into the plasma at 5 μl/min. The plasma remained uniform and filament-free.

The plasma was then passed over a stainless steel substrate and over an electronic printed circuit board (PCB) at a speed of 45 mm/sec. In both cases, the plasma deposited a stable smooth oleophobic coating onto the substrate without any evidence of arc or filament formation. On stainless steel, the coating produced had a water contact angle of 90° and a tetradecane contact angle of 50°.

### EXAMPLE 2

A siloxane coating was deposited onto a silicon wafer substrate 55 using the plasma jet apparatus of FIG. 4 at the following process parameters:
Plasma Power: 90% power requested from a 100 W 18 kHz RF generator
Helium flow: 5 slm
CO₂ flow: 50 sccm
Coating precursor: Tetramethyl cyclotetrasiloxane nebulized at 15 μl/minute

When no nitrogen was added to the process gas the system produced a filamentary discharge. The resultant coatings were white and contained significant powder particles. When nitrogen was added at 250 sccm, the coating contained a mixture of powder and clear coatings. When the nitrogen gas flow was increased to 350 sccm, the plasma appeared uniform and filament free and a clear coating was deposited on the wafer with no sign of particles.

When the plasma power was dropped to 50%, white and particulate coatings were still produced when no nitrogen was added to the process gas. Clear coatings were deposited with a flow rate of nitrogen of 140 sccm or higher up to 350 sccm.

When the power was increased to 60% and the flow rate of nitrogen was held at 140 sccm, the coatings were found to contain some evidence of particles. Keeping the power at 60%, it was found that clear coatings could be formed by adding 200 sccm nitrogen to the process gas flow.

### EXAMPLE 3

A further series of coatings were deposited using the equipment shown in FIG. 4. Tetramethyl cyclotetrasiloxane precursor was again introduced into the system at a flow rate of 90 microlitres per minute. The 100 W power supply was turned on to full power and helium gas was introduced at 10 litres per minute to produce a plasma. Coatings were then deposited onto silicon wafers with various flow rates of nitrogen (up to 500 mL/min) added. The experiment was repeated using two different plasma to substrate distances of 3 and 5 mm.

Once coated a Digital Instruments Dimension 5000 atomic force microscope was used to measure the surface roughness of the films deposited on the Silicon wafer substrates. Measurements were acquired using Tapping Mode with an amplitude set point of ˜0.9 times the free oscillation amplitude. The root-mean-square (RMS) roughness parameters were measured at three different locations per sample using a 20 micron×20 micron scan size and the results are provided in Table 1 below.

TABLE 1

| Power | Precursor Flow | Helium Flow | Nitrogen Flow | Gap | RMS |
|---|---|---|---|---|---|
| (%) | (μL/min) | (L/min) | (mL/min) | (mm) | (nm) |
| 100 | 90 | 10 | 60 | 5 | 52.2 |
| 100 | 90 | 10 | 60 | 3 | 157 |
| 100 | 90 | 10 | 125 | 5 | 4.96 |
| 100 | 90 | 10 | 125 | 3 | 14.3 |
| 100 | 90 | 10 | 250 | 5 | 1.93 |
| 100 | 90 | 10 | 250 | 3 | 2.9 |
| 100 | 90 | 10 | 500 | 5 | 1.77 |
| 100 | 90 | 10 | 500 | 3 | 9.51 |

It will be seen that the results show significant improvements in the presence of nitrogen. The roughness is clearly seen to decrease as the nitrogen level increases until the coatings become very smooth and the roughness approaches zero. This indicates a significant decrease in particle formation and incorporation as the nitrogen level increases.

1. A process for coating a surface, in which an atomized surface treatment agent is incorporated in a non-equilibrium atmospheric pressure plasma generated in a noble process gas or an excited and/or ionized gas stream resulting therefrom, and the surface to be treated is positioned to receive the atomized surface treatment agent which has been incorporated therein, is characterized in that the particle content of the coating formed on the surface is reduced by incorporating a minor proportion of nitrogen in the process gas.

2. A process for coating a surface in accordance with claim 1 comprising plasma coating the surface, in which an atomized surface treatment agent is incorporated in a non-equilibrium atmospheric pressure plasma generated in a noble process gas and the surface to be treated is placed in contact with the atmospheric pressure plasma containing the atomized surface treatment agent, characterized in that particle content of the coating formed on the surface is reduced by incorporating a minor proportion of nitrogen in the process gas.

3. A process according to claim 1 in which the non-equilibrium atmospheric pressure plasma is generated in a process gas comprising the noble gas and the atomized surface treatment agent.

4. A process according to claim 1 in which the atomized surface treatment agent is introduced into a non-equilibrium atmospheric pressure plasma generated in the noble process gas.

5. A process according to claim 1, characterized in that the atomized surface treatment agent comprises a polymerizable material and the coating formed on the surface comprises a polymer of the atomized surface treatment agent.

6. A process according to claim 5, characterized in that the polymerizable material is an organosilicon compound and the coating comprises a polyorganosiloxane.

7. A process according to claim 1, characterized in that the non-equilibrium atmospheric pressure plasma is generated within a dielectric housing having an inlet and an outlet by applying a radio frequency high voltage to at least one electrode positioned within the housing while causing the process gas to flow from the inlet past the electrode to the outlet, the plasma extending from the electrode to the outlet of the housing, and the surface to be treated is positioned adjacent to the outlet so that the surface is in contact with the plasma and is moved relative to the plasma outlet.

8. A process according to claim 7, characterized in that a tube formed at least partly of dielectric material extends outwardly from the outlet of the housing, whereby the end of the tube forms the plasma outlet and the plasma extends from the electrode to the plasma outlet, and the surface to be treated is positioned adjacent to the plasma outlet so that the surface is in contact with the plasma and is moved relative to the plasma outlet.

9. A process according to claim 1, wherein the non-equilibrium atmospheric pressure plasma is generated in a process gas by applying a radio frequency high voltage to at least one electrode in contact with the process gas, characterized in that the process gas comprises a noble gas and nitrogen in a proportion of from 90 parts by volume noble gas to 10 parts nitrogen up to 99.8 parts by volume noble gas to 0.2 parts nitrogen.

10. A process according to claim 9, characterized in that the radio frequency high voltage is applied to at least one electrode positioned within a dielectric housing having an inlet and an outlet while causing the process gas to flow from the inlet past the electrode to the outlet.

11. A process according to claim 10, characterized in that the radio frequency voltage applied is in the range 10 kV to 25 kV and the process gas comprises helium and nitrogen in a proportion of from 95 parts by volume noble gas to 5 parts nitrogen up to 99.5 parts by volume noble gas to 0.5 part nitrogen.

12. A process according to claim 11, characterized in that the radio frequency voltage applied is in the range 25 kV to 40 kV and the process gas comprises helium and nitrogen in a proportion of from 90 parts by volume noble gas to 10 parts nitrogen up to 99 parts by volume noble gas to 1 part nitrogen.

13. A process according to claim 9, characterized in that an atomized surface treatment agent is incorporated in the process gas whereby the plasma treatment coats the surface with a coating derived from the surface treatment agent.

14. A process for coating a surface by generating a non-equilibrium atmospheric pressure plasma in a noble process gas by applying a radio frequency high voltage to at least one electrode in contact with an atmosphere of the noble gas and incorporating an atomized surface agent in the plasma, the improvement wherein the noble gas contains a minor proportion of nitrogen, the amount of nitrogen being sufficient to reduce the particle content of the coating formed on the surface.

15. Use of a minor proportion of nitrogen in the process gas in a process for coating a surface, in which an atomized surface treatment agent is incorporated in a non-equilibrium atmospheric pressure plasma generated in a noble process gas or an excited and/or ionized gas stream resulting therefrom, and the surface to be treated is positioned to receive atomized surface treatment agent which has been incorporated therein, to reduce the particle content of the coating formed on the surface.

16. Use in accordance with claim 15 characterized in that the atomized surface treatment agent is incorporated in the non-equilibrium atmospheric pressure plasma generated in a noble process gas and the surface to be treated is placed in contact with the atmospheric pressure plasma containing the atomized surface treatment agent.

17. A process according to claim 2 in which the non-equilibrium atmospheric pressure plasma is generated in a process gas comprising the noble gas and the atomized surface treatment agent.

18. A process according to claim 2 in which the atomized surface treatment agent is introduced into a non-equilibrium atmospheric pressure plasma generated in the noble process gas.

19. A process according to claim 10, characterized in that an atomized surface treatment agent is incorporated in the process gas whereby the plasma treatment coats the surface with a coating derived from the surface treatment agent.

20. A process according to claim 11, characterized in that an atomized surface treatment agent is incorporated in the process gas whereby the plasma treatment coats the surface with a coating derived from the surface treatment agent.
